(19) United States
(12) Patent Application Publication
(10) Pub. No.: US 2016/0280166 A1
(43) Pub. Date: Sep. 29, 2016

(54) VEHICLE BUMPER STRUCTURE

(71) Applicants: TOYOTA MOTOR EAST JAPAN, INC., Kurokawa-gun (JP); TOYOTA JIDOSHA KABUSHIKI KAISHA, Toyota-shi (JP)

(72) Inventors: Hirokazu IKARUGI, Kurokawa-gun (JP); Takanori OKI, Kurokawa-gun (JP); Shogo SAKAI, Toyota-shi (JP); Yasuaki KOSUGI, Toyota-shi (JP)

(73) Assignees: TOYOTA JIDOSHA KABUSHIKI KAISHA, Toyota-shi (JP); TOYOTA MOTOR EAST JAPAN, INC., Kurokawa-gun (JP)

(21) Appl. No.: 14/855,840

(22) Filed: Sep. 16, 2015

(30) Foreign Application Priority Data
Mar. 25, 2015 (JP) 2015-063504

(51) Int. Cl. B60R 19/18

(52) U.S. Cl. CPC B60R 19/18; B60R 2019/1806

(57) ABSTRACT

The bumper structure includes: an upper part having an upper absorber; and a lower part having a lower absorber, wherein the upper absorber is in a structure having an upper receiving face at its front end, lower absorber is in a structure having a lower receiving face at its front end, the upper absorber is defined vertically into a first upper absorber having a first upper receiving face and a second upper absorber having a second upper receiving face, the second upper absorber and the lower absorber are formed softer than the first upper absorber.

### CROSS REFERENCE TO RELATED APPLICATIONS

This application claims priority based on 35 U.S.C. 119 from prior Japanese Patent Application No. 2015-63504 filed on Mar. 18, 2015, the entire contents of which are incorporated herein by reference.

### BACKGROUND OF THE INVENTION

1. Field of the Invention

The present invention relates to a vehicle bumper structure wherein upper and lower absorbers are arranged apart from each other.

2. Description of the Related Art

To improve the performance of protecting legs of pedestrians, bumper structures wherein upper and lower absorbers are arranged apart from each other have been proposed. Patent Literature 1 discloses a vehicle front structure wherein an upper impact absorbing member is inserted between a top bumper beam and a bumper face and a lower impact absorbing member is inserted between a lower frame and the bumper face in order to minimize damage to the lower limbs of pedestrians caused by accidental contact. Patent Literature 1 teaches that the lower frame of a radiator panel is used for supporting the lower absorber to eliminate the need for a bottom bumper beam and improve the degree of freedom of design by using the space thus generated.

Patent Literature 2 discloses a vehicle bumper downsized by adjusting the gap dimension between a bumper absorber and a bumper fascia, thereby increasing the amount of impact energy to be absorbed.

### CITATION LIST

### Patent Literature

Patent Literature 1: JP 2001-277964 A

Patent Literature 2: JP 2012-66717 A

With the technology disclosed in Patent Literature 1, if the performance of protecting the legs of pedestrians is ensured by using the absorbers arranged with the one above the other, it becomes difficult to ensure load absorption performance when large loads are applied at low speeds. Meanwhile, with the technology disclosed in Patent Literature 2, if the gap is adjusted vertically to ensure load absorption performance within the range of the height of the absorber, it becomes difficult to fulfill pedestrian protection performance.

### SUMMARY

The purpose of the present invention is to provide a bumper structure capable of maintaining load absorption performance and pedestrian protection performance simultaneously, even when large loads are imposed on the vehicle bumper at low speeds at more than one positions in height.

An aspect of the invention is to provide a vehicle bumper structure that can maintain load absorption performance and pedestrian protection performance at the same time even when large loads are applied at low speeds at two or more positions in height.

According to certain preferred embodiments of the invention, this aspect is achieved with a vehicle bumper structure including: an upper part having an upper absorber; and a lower part having a lower absorber arranged beneath and away from the upper absorber, the upper absorber having an upper receiving face, to which a load is applied, at its front end, and the lower absorber having a lower receiving face, to which a load is applied, at its front end.

The upper absorber is divided into a first upper absorber having a first upper receiving face and a second upper absorber having a second upper receiving face, and the second upper absorber and the lower absorber are formed softer than the first upper absorber.

According to a particularly preferred embodiment of the invention, a hollow is formed at a part in the front-back direction of the first upper absorber. This hollow helps the upper absorber to deliver further enhanced performance of protecting the legs of pedestrians.

The first upper absorber may be supported by a supporting member at the rear, and the hollow may be provided from the rear face supported by the supporting member toward the front. The supporting member may be a beam or reinforcement arranged in the width direction of the vehicle at the rear of the front vehicle bumper.

The second upper receiving face is arranged behind the first upper receiving face and the lower receiving face, and the lower receiving face is arranged at the same position as, or slightly ahead of, the first upper receiving face in the front-back direction of the vehicle.

The second upper absorber is desirably made of a foamed resin that is softer than the first upper absorber, and the second upper absorber and the lower absorber may be made of resins having an equal expansion ratio. The first and the second upper absorbers can be molded into one piece.

By placing the front end of the lower absorber at a position the same as or slightly ahead of the front end of the upper absorber, it becomes possible to throw up the lower part of the legs of a pedestrian who bumps into the vehicle.

According to the present invention, it is possible to provide a bumper structure that delivers load absorption performance and pedestrian protection performance at the same time, even if large loads are applied at low speeds to multiple positions in height of a vehicle bumper.

Other objects, advantages and novel features of the present invention will become apparent from the following detailed description of the invention when considered in conjunction with the accompanying drawings.

### BRIEF DESCRIPTION OF THE DRAWINGS

The foregoing and further objects, features and advantages of the invention will become apparent from the following description of example embodiments with reference to the accompanying drawings, wherein the same or corresponding portions will be denoted by the same reference numerals and wherein:

FIG. 1 is a schematic cross sectional view showing the front part of a vehicle to which the bumper structure according to the embodiment of the present invention is mounted.

FIG. 2 is a cross sectional view showing the upper absorber of the bumper structure shown in FIG. 1.

### DESCRIPTION OF EMBODIMENT OF THE INVENTION

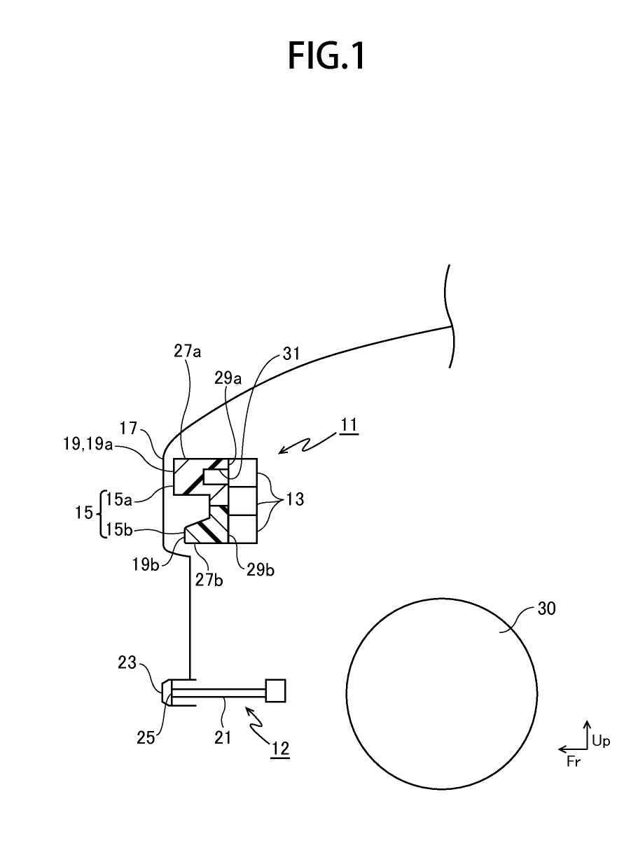

The embodiment of the present invention will hereinafter be described in detail by referring to the drawings. The embodiment of the present invention is an example where the invention is adopted to a front bumper mounted at the front end of a vehicle. Fr and Up in each drawing respectively represent the front and the upper sides of the vehicle. As shown in FIG. 1, the bumper structure according to the embodiment of the present invention includes an upper part 11 and a lower part 12.

The upper part 11 includes an upper absorber 15. This upper absorber 15 is fastened directly or indirectly to, and supported by, a bumper reinforcement 13 as a supporting member extending in the width direction of the vehicle. The front end of the upper absorber 15 is placed within an upper bumper face 17 that has roughly u-shaped cross section. At the front end of the upper absorber 15, upper receiving faces 19, to which loads are applied, are provided.

The lower part 12 includes a lower absorber 21 that is directly or indirectly supported by supporting part (not shown) such as vehicle framework and reinforcement. The lower absorber 21 is arranged beneath and apart from the upper absorber 15. The front end of the lower absorber 21 is placed within a lower bumper face 23 that has roughly u shaped cross section. At the front end of this lower absorber 21, a lower receiving face 25, to which a load is applied, is provided.

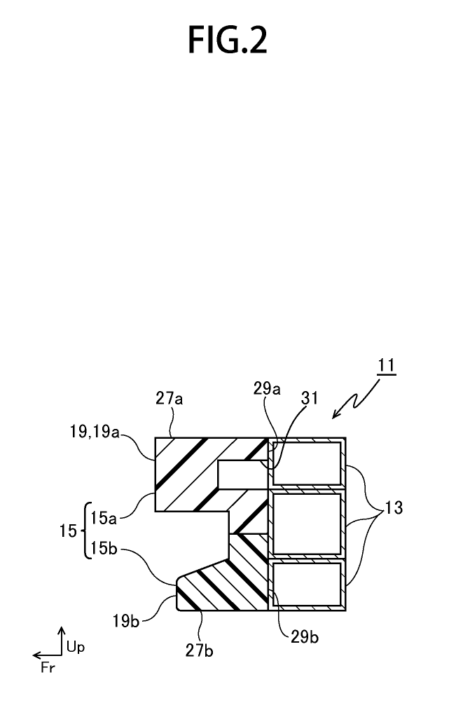

As shown in FIG. 2, the upper absorber 15 has a first upper absorber 15a and a second upper absorber 15b, each having different hardness, with the former above and adjacent to the latter. It is desirable that the first upper absorber 15a and the second upper absorber 15b be molded into one piece by two-color molding, etc., but they are allowed to be separate bodies. The first upper absorber 15a and the second upper absorber 15b are arranged with the former above the latter and adjacent to each other, and continuously extend in the width direction of the vehicle in respective predetermined cross sectional shapes.

The first upper absorber 15a includes a first protrusion 27a having a mostly constant width in the top-bottom direction and protruding toward the front side, and a first fixed part 29a having a width in the top-bottom direction wider than that of the first protrusion 27a. The front end of the first protrusion 27a is a first upper receiving face 19a constituting one of the upper receiving faces 19. The first fixed part 29a is fastened to and supported by a bumper reinforcement 13 at the rear end, and a hollow 31 is formed in this first fixed part 29a to weaken a part in the front-back direction.

The hollow 31 has its opening on the rear face of the first upper absorber 15a, which is supported by the bumper reinforcement 13, and is formed toward the front in a specified length. The shape, size, and depth of the hollow 31 are determined with the hardness, positions, shapes, and sizes of the first and the second upper absorbers 15a, 15b and the lower absorber 21 taken into consideration.

The first upper absorber 15a is made of a material capable of absorbing loads applied from the front by altering its shape. The material selected for the first upper absorber 15a is capable of absorbing large loads sufficiently not to cause damage such as deformation to other members of the vehicle, such as functional parts including a head lamp and hood, even if large loads are applied at low speeds to a portion of the first upper receiving face 19a where the hollow 31 is not formed. In the embodiment of the present invention, the upper absorber 15a is made of a hard resin that allows desired load absorption characteristics of the first upper absorber 15a to be exhibited, specifically a hard foamed resin having 0% or low expansion ratio.

The second upper absorber 15b includes a second protrusion 27b protruding toward the front side with its width in the top-bottom direction narrowed down toward the front side, and a second fixed part 29b whose width in the top-bottom direction is wider than that of the second protrusion 27b. A second upper receiving face 19b is provided at the front end of the second protrusion 27b. This second upper receiving face 19b is arranged apart from the first upper receiving face 19a to constitute one of the upper receiving faces 19. The second fixed part 29b is fastened to and supported by the bumper reinforcement 13 at the rear end. The second upper absorber 15b is arranged with its second upper receiving face 19b positioned behind the first upper receiving face 19a of the first upper absorber 15a. It is favorable that this second upper absorber 15b is arranged behind the first upper receiving face 19a and the lower receiving face 25 of the lower absorber 21, which will be described later.

The second upper absorber 15b is made of a material capable of absorbing loads applied from the front by altering its shape. It is desirable that a material capable of absorbing large loads be used for the second upper absorber 15b so that damage such as deformation does not occur to other members of the vehicle when the large loads are applied at low speeds from the front.

In this embodiment, the second upper absorber 15b is made of a resin that ensures desired load absorption characteristics, has higher expansion ratio, hence is softer, than the first upper absorber 15a. As such a foamed resin, the one used for the first upper absorber 15a can be selected, provided that it has a different expansion ratio. The second upper absorber 15b has hardness and shape allowing the load to be absorbed in a larger stroke than the first upper absorber 15a when the same load as the one applied to the first upper absorber 15a is applied.

As shown in FIG. 1, the lower part 12 includes a lower absorber 21 positioned beneath and apart from the upper absorber 15. The lower absorber 21 has, at its front end, a lower receiving face 25 to which loads are applied. It is desirable that the lower receiving face 25 of the lower absorber 21 be arranged at the same position as or ahead of the first upper receiving face 19a of the first upper absorber 15a in the front-back direction.

A molded resin capable of absorbing loads by altering its shape is used for the lower absorber 21. This resin can absorb the impact of a collision between the legs of a pedestrian and a vehicle sufficiently, ensuring the performance of protecting legs of the pedestrian. As such a material, a foamed resin can be used as in the case of the first and the second absorbers 15a, 15b, for example. The lower absorber 21 is formed softer than the first upper absorber 15a, and may have the same expansion ratio, hence the same hardness, as the second upper absorber 15b.

The behavior of a vehicle having the above bumper structure will hereinafter be described.

First, a case where a large load is applied to a high position of the bumper at a low speed will be discussed. For example, if a pendulum having a weight as heavy as the vehicle itself hits the bumper at a speed of 8 km/h or lower at the height of the vehicle of around 20 inches, the load is applied to the first upper receiving face 19a of the first upper absorber 15a via the upper bumper face 17. Then deformation occurs and crushing results from the rear side of the first upper absorber 15a where the hollow 31 is provided, and the front side where the hollow 31 is not provided is then deformed and crushed as well. Consequently, the applied energy is absorbed by the first upper absorber 15a sufficiently to prevent damage from occurring to other part of the vehicle.

Next, a case where a load the same as the one applied to the high position is applied at a low speed to a low position of the bumper will be discussed. For example, in a test where a pendulum having a weight as heavy as the vehicle itself is made to hit the bumper at a speed of 8 km/h or lower at the height of the vehicle of around 16 inches, the load is applied to the second upper receiving face 19b of the second upper absorber 15b via the upper bumper face 17. As a result, the front side of the second upper absorber 15b becomes deformed, and furthermore the rear side is also deformed and crushed. At this time, the stroke is larger compared to the case where the load is applied to a higher position of the vehicle bumper, and the applied energy is absorbed by the second upper absorber 15b sufficiently, preventing damage to other part of the vehicle.

Furthermore, in a case where a leg impactor simulating a leg of a pedestrian is made to hit a vehicle at the speed of 40 km/h, the load is applied to the first upper receiving face 19a of the first upper absorber 15a via the upper bumper face 17, and to the lower receiving face 25 of the lower absorber 21 via the lower bumper face 23. As a result, the rear side of the first upper absorber 15a where the hollow 31 is provided is deformed and crushed, and at the same time the lower absorber 21 is also deformed and crushed. At this time, since the second upper absorber 15b is placed behind and is made softer than the first upper absorber 15a, it contributes less to the absorption of the impact of the leg impactor. The applied energy is thus absorbed sufficiently by the rear side of the first upper absorber 15a and the lower absorber 21, thereby reducing the load to the leg impactor to prevent it from being damaged.

With the bumper structure described above, since the upper absorber 15 placed within the upper bumper face 17 is divided into the first upper absorber 15a and the second upper absorber 15b, different materials, shapes, arrangements, etc. can be adopted for the upper and the lower portions of the upper absorber 15, and thus specified performance can be achieved within the upper bumper face 17 in various shapes. The degree of freedom in design of bumpers can thus be improved.

It is also possible to allow the upper and the lower portions of the upper bumper face 17 to have different load absorption characteristics. In this case, the second upper absorber 15b is made to be softer than the first upper absorber 15a. By doing so, when a large load is applied at a low speed to the upper portion of the upper bumper face 17, the load can be absorbed by the first upper absorber 15a by a small stroke. Reversely, when a large load is applied at a low speed to the lower portion of the upper bumper face 17, the load can be absorbed by the second upper absorber 15b by a larger stroke. In this way, even when large loads are applied at low speeds to the bumper at multiple positions in height, load absorption performance corresponding to each height can be ensured.

In this embodiment, the upper absorber 15 and the lower absorber 21 are provided, the second upper absorber 15b is made softer than the first upper absorber 15a, and the second upper receiving face 19b is positioned behind the first upper receiving face 19a and the lower receiving face 25. Pedestrian protection performance can thus be ensured by the first upper absorber 15a and the lower absorber 21, with the function of the second upper absorber 15b minimized as far as possible.

In the embodiment of the present invention, since the first upper absorber 15a has the hollow 31 at a specified position in the front-back direction, the first upper absorber 15a can be weakened partially even if it is made to be harder than the second upper absorber 15b and the lower absorber 21. Pedestrian protection performance can thus be ensured by the first upper absorber 15a and the lower absorber 21. As described above, it is possible for the embodiment of the present invention to simultaneously ensure pedestrian protection performance and load absorption performance against large loads applied at low speeds at multiple positions in height of the vehicle bumper.

With the bumper structure in the embodiment of the present invention, the second upper absorber 15b is made of a foamed resin having a higher expansion ratio than the first upper absorber 15a, meaning that the second upper absorber 15b, which absorbs loads by changing its form, can be made light in weight. In addition, the hardness can be adjusted easily. In particular, if the first upper absorber 15a and the second upper absorber 15b are made of an identical resin or of resins in the same series but having different expansion ratios, their hardness can be set by adjusting the expansion ratios. Accordingly, adjustment of the hardness of the first upper absorber 15a and that of the second upper absorber 15b is facilitated, and thus, such a bumper structure can be manufactured easily.

According to the bumper structure in the embodiment of the present invention, since the hollow 31 is provided in the first upper absorber 15a from the rear face supported by the bumper reinforcement 13 toward the front, the specified length in the rear of the first upper absorber 15a can be weakened easily by adjusting the shape, size, depth, etc. of the hollow 31. Consequently, when a large load is applied at a low speed, the part of the first upper absorber 15a where the hollow 31 is not provided ensures desired load absorption performance, whereas the part where the hollow 31 is provided ensures the performance of protecting the legs of pedestrians.

This embodiment can be altered as required within the scope of the present invention. The example where the first and the second upper absorbers 15a, 15b and the lower absorber 21 are made of solid foamed resins was described as the embodiment of the present invention. However, any materials such as non-foamed resins and hollow metal members can be used, provided that they absorb the load applied to each receiving face 19a, 19b, and 25 by altering their form.

The case where the upper absorber 15 includes the first upper absorber 15a and the second upper absorber 15b was described as the embodiment of the present invention. However, the upper absorber 15 may be divided vertically into three or more portions.

This embodiment operates most efficiently by applying it to the front bumper from the viewpoint of pedestrian protection. However, the application is not necessarily limited to this embodiment. Those skilled in the art must easily see that it is also applicable to the rear bumper of a vehicle.

### REFERENCE SIGNS LIST

11: Upper part
12: Lower part
13: Bumper reinforcement
15: Upper absorber
15a: First upper absorber
15b: Second upper absorber
17: Upper bumper face
19: Upper receiving face
19a: First upper receiving face
19b: Second upper receiving face
21: Lower absorber
23: Lower bumper face
25: Lower receiving face
27a: First protrusion
27b: Second protrusion
29a: First fixed part
29b: Second fixed part
30: Wheel
31: Hollow

What is claimed is:

1. A vehicle bumper structure, comprising:
an upper part having an upper absorber; and
a lower part having a lower absorber arranged beneath and apart from the upper absorber, the upper absorber having an upper receiving face, to which loads are applied, at its front end, and the lower absorber having a lower receiving face, to which loads are applied, at its front end,
wherein the upper absorber is defined into a first upper absorber having a first upper receiving face and a second upper absorber having a second upper receiving face, and
the second upper absorber and the lower absorber are formed softer than the first upper absorber.

2. The vehicle bumper structure as set forth in claim 1,
wherein the upper absorber and the lower absorber are respectively supported by a supporting member at their rear ends.

3. The vehicle bumper structure as set forth in claim 1,
wherein the first upper absorber and the second upper absorber are made of the same material and made into one body, defined at a central position in the top-bottom direction into a first protrusion having a first upper receiving face and a second protrusion having a second upper receiving face via a dent formed in between in the width direction of the vehicle, and arranged so as to extend in the width direction of the vehicle adjacent to each other.

4. The vehicle bumper structure as set forth in claim 1,
wherein the first upper absorber and the second upper absorber are made of different materials, and arranged adjacent to each other, extending in the width direction of the vehicle.

5. The vehicle bumper structure as set forth in claim 1,
wherein the first upper absorber has a first fixed part on its rear end, the first fixed part having a hollow for weakening a part in the front-back direction.

6. The vehicle bumper structure as set forth in claim 5,
wherein the hollow is provided, opening at the first fixed part of the first upper absorber and being hollowed in a specified depth toward the front.

7. The vehicle bumper structure as set forth in claim 1,
wherein the second upper absorber has a second fixed part supported by the supporting part at its rear end, and protrudes from the second fixed part with its width in top-bottom direction decreasing toward the front end, the front end constituting the second upper receiving face.

8. The vehicle bumper structure as set forth in claim 1,
wherein the second upper receiving face is arranged closer to the rear end of the vehicle than the first upper receiving face and the lower receiving face.

9. The vehicle bumper structure as set forth in claim 1,
wherein the lower receiving face is arranged at the same position as or ahead of the first upper receiving face.

10. The vehicle bumper structure as set forth in claim 1,
wherein the first upper absorber is made of a hard foamed resin that can provide load absorption characteristics of a degree preventing damage from being caused to members of the vehicle when a large load is applied at a low speed to the first upper receiving face.

11. The vehicle bumper structure as set forth in claim 1,
wherein the first upper absorber and the second upper absorber are respectively made of foamed resins having different expansion ratios, the second upper absorber has a higher expansion ratio, hence is softer, than the first upper absorber, and when a large load is applied at a low speed to the second upper receiving face, the second upper absorber absorbs that load by a larger stroke than the first upper absorber so that load absorption characteristics of a degree preventing members of the vehicle from being damaged can be obtained.

12. The vehicle bumper structure as set forth in claim 1,
wherein the lower absorber is made of a foamed resin having a higher expansion ratio, hence is softer than, the first upper absorber, and thus has load absorption characteristics allowing an impact of legs of a pedestrian hitting the vehicle to be absorbed.

13. The vehicle bumper structure as set forth in claim 12,
wherein the foamed resin of the lower absorber has the same expansion ratio as the second upper absorber.

14. The vehicle bumper structure as set forth in claim 5,
wherein the hollow in the first upper absorber and the lower absorber ensure protection of legs of pedestrians.

15. The vehicle bumper structure as set forth in claim 1,
wherein the upper part and the lower part are respectively arranged within an upper bumper face and a lower bumper face.

16. The vehicle bumper structure as set forth in claim 15,
wherein the upper bumper face and the lower bumper face are formed into one piece.

17. The vehicle bumper structure as set forth in claim 5,
wherein the first fixed part having the hollow on the rear side of the first upper absorber is crushed first, and then the first upper receiving face on the front side deforms, thereby absorbing the load applied to the first upper receiving face at a low speed.

18. The vehicle bumper structure as set forth in claim 17,
wherein the front side of the second upper absorber deforms first, and then the rear side deforms, thereby absorbing the applied energy by a larger stroke than the first upper absorber, when a load is applied to the second upper receiving face at a low speed.

19. A vehicle bumper structure, comprising:
an upper part having an upper absorber; and
a lower part having a lower absorber arranged beneath and apart from the upper absorber, the upper absorber having an upper receiving face, to which loads are applied, at its front end, and the lower absorber having a lower receiving face, to which loads are applied, at its front end,
wherein the upper absorber is defined into a first upper absorber having a first upper receiving face and a second upper absorber having a second upper receiving face,
the second upper absorber and the lower absorber are formed softer than the first upper absorber,
the first upper absorber has a fixed part on its rear end, the fixed part having a hollow for weakening a part in the front-back direction, and
the second upper receiving face is arranged closer to the rear end of the vehicle than the first upper receiving face and the lower receiving face.
